(19) United States
(12) Patent Application Publication
(10) Pub. No.: US 2017/0325290 A1
(43) Pub. Date: Nov. 9, 2017

(54) Method for Producing a Contact Region for a Layer of an Electrical Heating Device and Apparatus for an Electrical Heating Device for a Motor Vehicle

(71) Applicant: Webasto SE, Stockdorf (DE)

(72) Inventor: Thorsten KABELITZ, Stockdorf (DE)

(21) Appl. No.: 15/524,568

(22) PCT Filed: Nov. 9, 2015
(86) PCT No.: PCT/EP2015/076068

§ 371 Date: May 4, 2017

(30) Foreign Application Priority Data
Nov. 7, 2014 (DE) 10 2014 116 275.7

(51) Int. Cl. H05B 3/26; B23K 26/342; H01B 13/00; H01B 1/02; B23K 101/38; B23K 103/12

(52) U.S. Cl. CPC H05B 3/26; H01B 13/0016; H01B 1/026; B23K 26/342; B23K 2203/12; B23K 2201/38; H05B 2203/013; H05B 2203/016; H05B 2203/017

(57) ABSTRACT

A method for producing a contact region for a layer of an electrical heating device for a motor vehicle may include providing the layer made of a thermally sprayed, electrically conductive material, providing a laser beam having a focus, introducing a powder of an electrically conductive material into the focus of the laser beam, and thereby melting the powder, applying the molten powder to a region of the layer, and thereby forming the contact region from the electrically conductive material for making contact with the layer.

Heating devices are used in motor vehicles in order to heat the interior of the motor vehicle. In this respect, use is also made of electrical resistance heating devices. These comprise a heating conductor layer which heats up upon the application of an electrical voltage. To this end, the heating conductor layer has to be electrically connected to a voltage source during operation.

It is desirable to specify a method for producing a contact region for a layer of an electrical heating device for a motor vehicle which allows for simple and reliable production. In addition, it is desirable to specify an apparatus for an electrical heating device for a motor vehicle which allows for reliable operation.

One aspect of the invention relates to a method for producing a contact region for a layer. The layer is designed for operation in an electrical heating device for a motor vehicle. In particular, during operation the layer is part of an electrical heating device of a motor vehicle. The layer made of a thermally sprayed, electrically conductive material is provided. The layer has a predefined electrical conductivity. The layer is in particular made of a metal or comprises a metal. A laser beam having a focus is provided. A powder of an electrically conductive material is introduced into the focus of the laser beam. The powder is melted in the focus of the laser beam. The molten powder is applied to a region of the layer. The contact region is thereby formed from the electrically conductive material for making contact with the layer.

The layer is, for example, a heating conductor layer. According to further embodiments, the layer is a capping electrode layer. According to further embodiments, provision is made of a plurality of thermally sprayed layers, on each of which such a contact region is formed.

The contact region for the layer is formed from the conductive material. It is therefore possible to couple the layer to a voltage source by means of the contact region. The contact region is also referred to as a contact pad. By way of example, the contact region serves to be welded and/or soldered to a lead, for example to a contact plate or a cable. The energy of the laser is used to melt the powder. In the molten state, it is possible to achieve a good connection between the conductive material and the layer. A form-fitting and/or integral connection is therefore formed between the conductive material and the layer once the powder is cooled again. The contact region is applied to the layer, which comprises thermally sprayed material, by means of powder build-up welding. The contact region is in particular not applied by a thermal spraying method.

According to embodiments, the focus of the laser beam, at which the highest energy density and/or power density of the laser beam occurs, is spaced apart from the surface of the layer. This avoids damage to the layer. The heating conductor layer and/or the capping electrode layer are not melted. This avoids damage to the underlying layers, in particular damage to an insulating layer. In particular, the spacing is chosen to be so great that the surface of the layer is not melted. The powder is melted in the focus at a spacing from the surface and propelled onto the surface. As a result, it is possible to dispense with a masking which predefines the outer dimensions of the contact region. A masking of this type is commonly used, for example, in the case of thermal spraying. Material is applied only where the molten pool is produced. The use of material for producing the contact region is comparatively small. Powder which is not used in the direct process can be reused. By way of example, powder which does not adhere and which does not become part of the contact region is reused.

The electrically conductive material is, in particular, an electrically conductive metal, for example copper. The molten powder is applied in such a way that the contact region is formed as a homogeneous layer made of the metal. A low degree of oxidation can be realized. In contrast to other production methods, such as for example specific thermal spraying methods, no porous structures are therefore produced.

According to embodiments, the powder is introduced by means of a gas stream. By way of example, the gas stream is oriented in such a way that the powder passes to the focus of the laser beam and subsequently impinges on the surface of the layer.

According to embodiments, the layer is produced by means of a thermal spraying method. To this end, the electrically conductive material for the layer is applied to the surface of a carrier layer in a form molten by means of a spray burner. The layer is therefore built up in plies. An electric arc, a plasma beam or a flame is used, for example, for melting the electrically conductive material. The electrically conductive material for the layer is, for example, a metallic material, in particular the layer comprises nickel-chromium (NiCr). The contact region is applied not to a solid material but rather to a thermally sprayed layer.

By way of example, in the subsequent processing of the layer and of the contact region, an electrical contact-making means, in particular a copper strip, is connected to the contact region, in particular welded thereon.

According to a further aspect of the invention, an apparatus for an electrical heating device for a motor vehicle comprises a layer made of a thermally sprayed, electrically conductive material. The apparatus comprises a contact region for making electrical contact with the layer. The contact region is formed from an electrically conductive homogeneous material and is connected to the layer in a form-fitting and/or integral manner. The contact region comprises in particular copper or is formed from copper.

By way of example, the layer is a heating conductor layer. According to further embodiments, the layer is a capping electrode layer. According to further embodiments, provision is made of a plurality of thermally sprayed layers, which each comprise a contact region of this type.

By providing a homogeneous material for the contact region, the material beneath the contact region, in particular the layer, is well protected during the further processing of the apparatus. By way of example, during the welding of an electrical lead onto the contact region, damage to the layer is avoided, since the contact region is formed from homogeneous material. In contrast thereto, in the case of contact regions made of porous material, for example in the case of production by thermal spraying, the risk of material beneath the contact region being damaged during the welding is higher.

In particular, the contact region is produced by means of at least one embodiment of the method described above. By way of example, the contact region is produced by what is termed laser build-up welding.

The layer is in particular produced by means of a thermal spraying method.

The features and advantages specified in conjunction with the apparatus are also applicable in connection with the production method, and vice versa.

Further advantages, features and developments will become apparent from the following examples explained in connection with the figures. Identical elements, similar elements and elements with the same effect may be provided with the same reference signs here. The elements illustrated and the size ratios thereof in relation to one another are in principle not to be considered as true to scale.

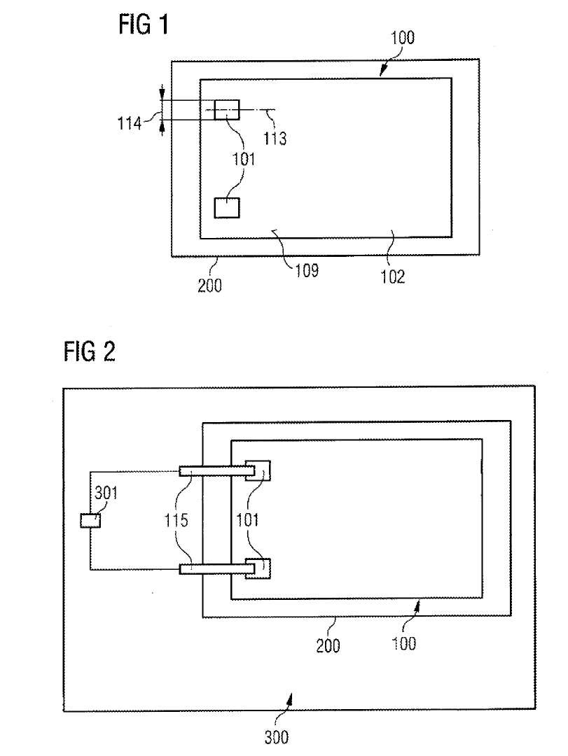

FIG. 1 shows a schematic illustration of a heating device according to embodiments,

FIG. 2 shows a schematic illustration of a motor vehicle according to embodiments,

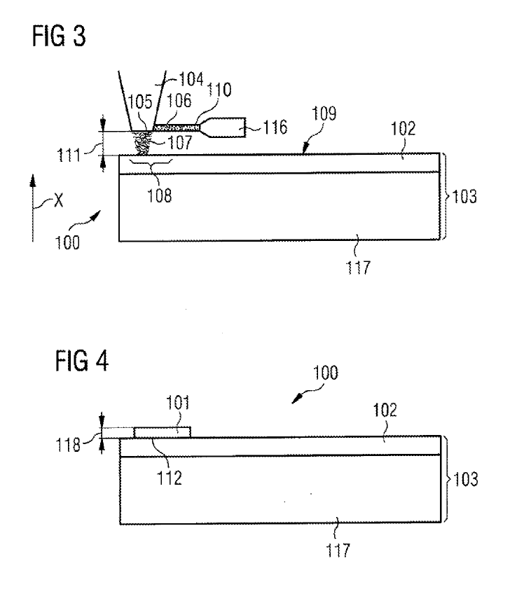

FIG. 3 shows a schematic illustration of an apparatus during the production according to embodiments,

FIG. 4 shows a schematic illustration of the apparatus according to embodiments.

FIG. 1 shows a heating device 200. The heating device 200 is in particular an electrical resistance heating device. The heating device 200 is designed to be used in a motor vehicle 300 (FIG. 2).

The heating device 200 comprises an apparatus 100. The apparatus 100 comprises a layer 102. In the exemplary embodiments illustrated, the layer 102 is a heating conductor layer 102. According to further exemplary embodiments, the layer is alternatively or additionally another layer of the heating device 200, which is produced by means of thermal spraying. By way of example, the layer 102 is a capping electrode layer, which at least partially covers the heating conductor layer 102 on a side remote from a substrate. By means of the capping electrode layer, it is possible in particular to detect a defect of the heating conductor layer. To this end, a test voltage is applied between the heating conductor layer and the capping electrode layer. In the case of a defect, the connection is of low impedance, but otherwise it is of high impedance. In order to connect the capping electrode to the voltage source, the capping electrode is formed with contact regions, in a manner corresponding to the contact regions as described hereinbelow.

The heating conductor layer 102 is formed from a material which heats up upon the application of an electrical voltage. It is therefore possible to use the apparatus 100 as an electrical heating system of the heating device 200. The heating conductor layer 102 is in particular produced by means of thermal spraying. According to further exemplary embodiments, the heating conductor layer is produced by means of another method, which is suitable for applying the conductive material for the heating conductor layer to further layers 117 (FIGS. 3 and 4).

Two contact regions 101 are formed on a surface 109 of the heating conductor layer 102. The contact regions 101 serve for making electrical and/or mechanical contact with the heating conductor layer 102. One of the contact regions 101 will be described hereinbelow, with the description applying correspondingly for the second contact region 101.

The contact region 101 is connected to the heating conductor layer 102 in a form-fitting and/or integral manner. The contact region 101 and the heating conductor layer 102 are connected in such a way that an electrically conductive connection 112 (FIG. 4) is formed. The contact region 101 therefore forms an interface with the electrical contact-making means of the heating conductor layer 102.

The contact region 101 comprises copper or is formed from copper or a copper-containing alloy. According to further exemplary embodiments, the contact region is formed from another metallic alloy. The contact region 101 has a width 114 along a longitudinal axis 113, for example, of more than 10 mm, in particular 15 mm+/−1%. The longitudinal axis runs along the spatial direction in which the contact region 101 has its greatest extent. By way of example, the contact region has a thickness 118 (FIG. 4) transversely to the longitudinal direction 113 of more than 200 μm, in particular approximately 300 μm.

FIG. 2 shows a schematic illustration of the motor vehicle 300. The motor vehicle 300 comprises the heating device 200. During operation, according to exemplary embodiments, the contact region 101 is electrically conductively connected to a contact plate 115. The contact plate 115 is electrically coupled to a voltage source 301. By way of example, the two contact regions 101 thus form the possible connections for the positive terminal and the negative terminal of the voltage source 301. The voltage source 301 is designed in particular to provide voltage of 100 volts or more. The heating device 200 is operated in the motor vehicle 300 with 100 volts or more, in order to provide heat.

According to embodiments, the contact plate 115 comprises copper or is formed from copper. By way of example, the contact plate 115 and the contact region 101 are welded to one another, such that an integral connection is formed. According to further embodiments, other connection methods are possible, for example soldering. According to further embodiments, an electrically conductive wire, for example, rather than a contact plate is connected directly to the contact region 101.

FIG. 3 shows the apparatus 100 during the production of the contact region 101 in cross section.

The apparatus 100 comprises a layer stack 103. The heating conductor layer 102 is part of the layer stack 103. The layer stack 103 comprises the further layers 117. The heating conductor layer 102 is in particular sprayed thermally onto the further layers 117. The further layers 117 are, for example beginning at the heating conductor layer: an insulating layer, a primer layer and a substrate. The heating conductor layer 102 comprises in particular nickel-chromium (NiCr).

A focus 105 of a laser beam 104 is arranged at a spacing 111. The laser beam is generated, for example, by a disk laser or a fiber laser; use is made for example of an Nd:YAG laser (neodymium-doped yttrium aluminum garnet laser). Other types of laser are also possible. The laser beam 104 is arranged above a region 108 of the heating conductor layer 102, in which the contact region 101 is to be formed.

A nozzle 116 for forming a gas stream 110 is provided, in order to produce powder 106 made of the conductive material for the contact region 101. The gas stream 110 is oriented in relation to the surface 109 in such a way that the conductive material impinges on the surface 109 in the region 108. The gas stream 110 is oriented in such a way that the powder 106 is heated and melted by means of the laser beam 104, in particular in the region of the focus 105. Subsequently, the molten powder 107 is transported in the direction of the surface, where it forms the contact region 101 (FIG. 4).

For producing the contact region 101, according to embodiments, the copper powder 106 is introduced directly into the laser beam 104. The copper powder 106 is melted by the laser energy. The molten pool of the molten powder 107 which is produced creates a layer on the surface 109. The particles of the molten powder 107 undergo an integral and/or form-fitting connection with one another on the surface 109. The molten powder 107 is applied to the surface 109 in such a way that in particular only a single layer is formed in the contact region 101 (FIG. 4). No porous structures are formed in the contact region 101.

In particular, material is applied only where the molten pool has been produced by the laser beam 104. It is therefore possible to dispense with a mask. By way of example, in the case of thermal spraying, use is conventionally made of a mask in order to mask those locations which are not to be coated. The laser strategy, or the laser parameters, is or are chosen in such a way that the heating conductor layer 102 and the further layers 117 are not melted. To this end, the focus 105 is arranged at the spacing 111 to the surface 109. The spacing 111 is in particular in X directions of FIG. 3. The laser parameters furthermore comprise the used wavelength of the laser beam 104, the used energy of the laser beam 104, the use of a continuously radiating or a pulsed laser. In particular, optics are used for the laser in order to realize a predefined beam quality. The beam quality is predefined in such a way that the powder 106 can be melted by the laser beam 104.

Dense, homogeneous layers with good adhesion to the heating conductor layer 102 are therefore formed alongside one another, for example, on the surface. Particularly if the contact plate 115 is welded onto the contact region 105, a contact region 105 applied in this way is advantageous, since the homogeneous contact region 101 made of solid material effectively protects the layers of the layer stack 103 during the welding. Dense copper layers for the contact region 101 are produced by the laser build-up welding. The material use for copper powder 106 is small; in particular, the powder which is not deposited in the contact region 101 can be reused. The process time for forming the contact region 101 lies in the range of seconds. Optical components are used for forming the laser beam 104, such that the width 114 of up to 15 mm is realized. By way of example, in order to generate the laser beam 104, use is made of a fiber laser with a power of 1 kilowatt. In particular, use is made of a fiber laser with a round or rectangular fiber Nd:YAG or a disk laser. The laser beam 104 is set in such a way that the material of the layer stack 103 on the surface 109 is not melted. Only the powder 106 is melted in the focus 105 and subsequently propelled onto the surface 109, in particular by means of the gas stream 110.

The molten powder 107 adheres on the surface 109 in the region 108. The powder particles of the powder 107 undergo an integral connection with one another. In addition, the molten powder particles undergo an integral and/or form-fitting connection with the heating conductor layer 102. On account of the short process time, little oxidation occurs in and at the contact region 101.

1. A method for producing a contact region for a layer of an electrical heating device for a motor vehicle, comprising the steps of:
providing the layer made of a thermally sprayed, electrically conductive material,
providing a laser beam having a focus,
introducing a powder of an electrically conductive material into the focus of the laser beam, and thereby
melting the powder,
applying the molten powder to a region of the layer, and thereby
forming the contact region from the electrically conductive material for making contact with the layer.

2. The method according to claim 1, in which the step of providing of the layer comprises:
providing a heating conductor layer made of the thermally sprayed, electrically conductive material.

3. The method according to claim 1, in which the powder is introduced by a gas stream.

4. The method according to claim 1, in which the step of introducing of the powder comprises:
introducing a copper powder.

5. The method according to claim 1, in which the laser beam is provided in such a way that the focus is at a spacing from a surface of the layer.

6. The method according to claim 1, in which the molten powder is applied in such a way that the contact region is formed as a homogeneous layer.

7. The method according to claim 1, in which the step of providing the layer made of an electrically conductive material comprises the step of:
thermally spraying the electrically conductive material to produce the layer.

8. An apparatus for an electrical heating device for a motor vehicle, comprising:
a layer made of a thermally sprayed, electrically conductive material, and
a contact region for making electrical contact with the layer, which contact region is formed from an electrically conductive homogeneous material and is connected to the layer in a form-fitting and/or integral manner.

9. The apparatus according to claim 8, in which the layer comprises a heating conductor layer.

10. The apparatus according to claim 8, in which the contact region comprises copper.

11. The apparatus according to claim 8, in which the contact region has a width along a longitudinal axis of more than 10 millimeters.

12. The apparatus according to claim 8, in which a contact plate is welded onto the contact region.

13. An apparatus for an electrical heating device for a motor vehicle, comprising:
a layer made of a thermally sprayed, electrically conductive material, and
a contact region for making electrical contact with the layer, which contact region is formed from an electrically conductive homogeneous material and is connected to the layer in a form-fitting and/or integral manner, and, in which the contact region is produced by means of a method according to claim 1.

14. The apparatus according to claim 11, in which the contact region has a width along a longitudinal axis of approximately 15 millimeters.
